(19) United States
(12) Patent Application Publication
(10) Pub. No.: US 2021/0329135 A1
(43) Pub. Date: Oct. 21, 2021

(54) INFORMATION PROCESSING DEVICE AND NON-TRANSITORY COMPUTER READABLE MEDIUM STORING PROGRAM

(71) Applicant: FUJIFILM Business Innovation Corp., Tokyo (JP)

(72) Inventors: Kunihiko KOBAYASHI, Kanagawa (JP); Shintaro ADACHI, Kanagawa (JP); Shusaku KUBO, Kanagawa (JP); Shigeru OKADA, Kanagawa (JP); Yusuke SUZUKI, Kanagawa (JP)

(73) Assignee: FUJIFILM Business Innovation Corp., Tokyo (JP)

(21) Appl. No.: 17/063,711

(22) Filed: Oct. 5, 2020

(30) Foreign Application Priority Data
Apr. 17, 2020 (JP) 2020-074062

(51) Int. Cl. H04N 1/00

(52) U.S. Cl. CPC H04N 1/00331; H04N 1/0044; H04N 1/00466

(57) ABSTRACT

An information processing device includes a processor configured to obtain a document image which shows a document; and switch a display destination of a correction screen which receives an operation of correcting a result of character recognition performed on the document image.

### CROSS-REFERENCE TO RELATED APPLICATIONS

This application is based on and claims priority under 35 USC 119 from Japanese Patent Applications No. 2020-074062 filed on Apr. 17, 2020.

### BACKGROUND

### (i) Technical Field

The present disclosure relates to an information processing device and a non-transitory computer readable medium storing a program.

### (ii) Related Art

A technique is known that performs character recognition on a document image which shows a document. For instance, Japanese Unexamined Patent Application Publication No. 2019-40250 states that optical character recognition (OCR) is performed on a scan image obtained by scanning a document, and supplementary information is set for predetermined processing using a character string extracted by the OCR processing.

### SUMMARY

A result of character recognition performed on a document image is not necessarily correct. Thus, a correction screen for receiving an operation of correcting a result of character recognition may be displayed so that a user can correct the result of character recognition. However, for instance, when the display destination of the correction screen is always an image reading device which reads a document, and if a display and an operational unit of the image reading device do not have sufficient capability for making corrections on the result of character recognition, it may be difficult to perform the operation. However, when the display destination of the correction screen is always a terminal device of a user, it is not possible to correct the result of character recognition if the terminal device is not provided with a program necessary for the processing of correcting the result of character recognition.

Aspects of non-limiting embodiments of the present disclosure relate to an information processing device that facilitates an operation of correcting a result of character recognition, as compared with when a correction screen for receiving the operation is displayed on a specific display destination.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including a processor configured to obtain a document image which shows a document; and switch a display destination of a correction screen which receives an operation of correcting a result of character recognition performed on the document image.

### BRIEF DESCRIPTION OF THE DRAWINGS

Exemplary embodiments of the present disclosure will be described in detail based on the following figures, wherein:

FIG. 1 is a view illustrating an example of the configuration of an attribute extraction system according to an exemplary embodiment;

FIG. 2 is a diagram illustrating an example of the configuration of an image processing device;

FIG. 3 is a diagram illustrating an example of the configuration of a terminal device;

FIG. 4 is a view illustrating an example of a setting screen;

FIG. 5 is a sequence chart illustrating an example of attribute extraction processing;

FIG. 6 is a diagram illustrating an example of a menu screen;

FIG. 7 is a view illustrating an example of a document image;

FIG. 8 is a view illustrating an example of a correction screen;

FIG. 9 is a view illustrating an example of a notification screen; and

FIG. 10 is a view illustrating an example of another correction screen.

### DETAILED DESCRIPTION

### 1. CONFIGURATION

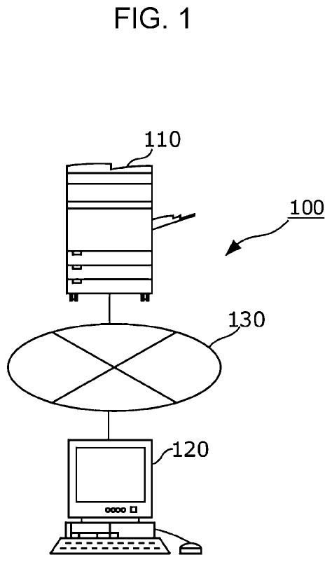

FIG. 1 is a view illustrating an example of the configuration of an attribute extraction system 100 according to an exemplary embodiment. The attribute extraction system 100 extracts attribute information from a document image obtained by reading a document, the attribute information indicating an attribute of the document. The document is a ledger sheet such as a price estimate and an invoice, for instance. For instance, when the document is a price estimate, a destination, a date of creation, a control number, and a period are used as the attribute information. Thus extracted attribute information is utilized for a file name and a folder name, for instance. When the attribute information is extracted, character recognition processing is performed on a document image, and the result of the character recognition may include an error. Thus, in the attribute extraction system 100, a user checks the result of the character recognition, and corrects the result as needed. The attribute extraction system 100 includes an image processing device 110 and a terminal device 120. These devices are connected via a communication line 130. The communication line 130 includes, for instance, a local area network (LAN).

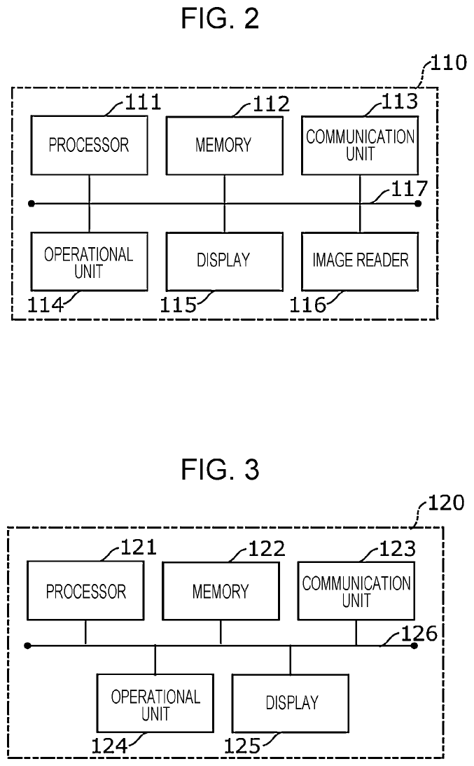

FIG. 2 is a diagram illustrating an example of the configuration of the image processing device 110. The image processing device 110 has a scan function, that is, reads a document and obtains a document image. In addition, the image processing device 110 has a function of extracting attribute information by performing character recognition processing on a document image. Furthermore, the image processing device 110 has a function of supporting a user in check and correction work (hereinafter referred to as “correction work”) on the result of character recognition in the attribute information. The image processing device 110 is an example of an information processing device or an image reading device according to the present disclosure. The image processing device 110 includes a processor 111, a memory 112, a communication unit 113, an operational unit 114, a display 115, and an image reader 116. These components are connected via a bus 117.

The processor 111 executes a program stored in the memory 112, thereby controlling the components of the image processing device 110 and performing processing to implement the functions of the image processing device 110. For instance, a central processing unit (CPU) is used as the processor 111. The memory 112 stores a program for implementing the functions of the image processing device 110. For instance, a read only memory (ROM) and a random access memory (RAM) are each used as the memory 112. In addition to the ROM and the RAM, for instance, a hard disk communication drive or a solid state drive (SSD) may be used as the memory 112. The communication unit 113 is connected to the communication line 130. The communication unit 113 performs data communication with other devices via the communication line 130. The operational unit 114 is used for the operation of the image processing device 110 by a user. For instance, a touch panel and a button are used for the operational unit 114. The display 115 displays various screens used for exchanging information with a user. These screens include a correction screen used for checking and correcting the result of character recognition of attribute information. For instance, a liquid crystal display is used as the display 115. The image reader 116 reads an image and converts the image into a digital signal. For instance, an image scanner is used as the image reader 116.

FIG. 3 is a diagram illustrating an example of the configuration of the terminal device 120. The terminal device 120 is used by each user. For instance, a personal computer is used as the terminal device 120. The terminal device 120 has a function of supporting a correction work of a user. Like this, in the attribute extraction system 100, both the image processing device 110 and the terminal device 120 have a function of supporting a correction work of a user. The terminal device 120 includes a processor 121, a memory 122, a communication unit 123, an operational unit 124, and a display 125. These components are connected via a bus 126.

The processor 121 executes a program stored in the memory 122, thereby controlling the components of the terminal device 120 and performing processing to implement the functions of the terminal device 120. For instance, a CPU is used as the processor 121. The memory 122 stores a program for implementing the functions of the terminal device 120. The program includes, for instance, a paid program necessary for correcting the result of character recognition of attribute information. For instance, a ROM and a RAM are each used as the memory 122. In addition to the ROM and the RAM, for instance, a hard disk communication drive or an SSD may be used as the memory 122. The communication unit 123 is connected to the communication line 130. The communication unit 123 performs data communication with other devices via the communication line 130. The operational unit 124 is used for the operation of the terminal device 120 by a user. For instance, a keyboard and a mouse are used for the operational unit 124. The display 125 displays various screens used for exchanging information with a user. These screens include a correction screen used for checking and correcting the result of character recognition of attribute information. For instance, a liquid crystal display is used as the display 125.

### 2. OPERATION

In the following description, when the processor 111 or 121 is described as the processing subject, this indicates that the processor 111 or 121 performs calculation by the cooperation between the program stored in the memory 112 or 122 and the processor 111 or 121 which executes the program, or performs processing by controlling the operation of the other hardware elements.

### 2.1 Initial Setting

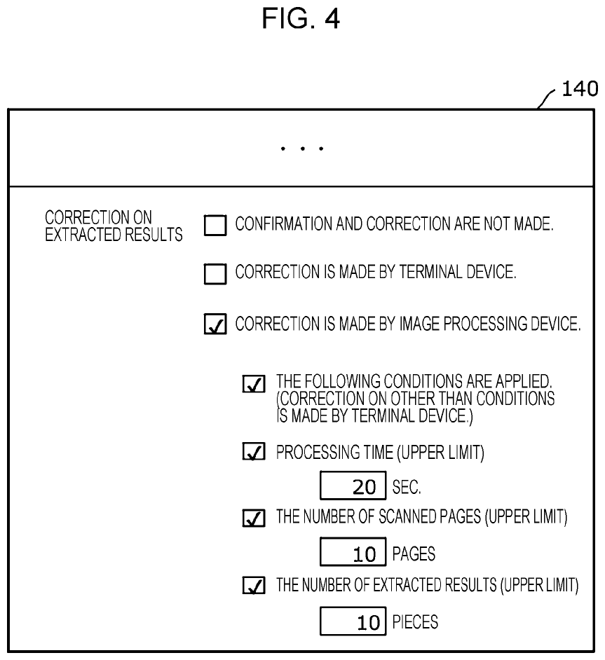

An administrator makes initial setting before the image processing device 110 is utilized. It is to be noted that the administrator is included in the users of the image processing device 110 in a broad sense. In the initial setting, at least one of a manner of extracting attribute information, a work destination of a correction work, and a condition for determining the work destination is set. FIG. 4 is a view illustrating an example of a setting screen 140 which is displayed on the display 115 of the image processing device 110 at the time of initial setting. The setting screen 140 receives an operation of setting a work destination of a correction work in the initial setting. The work destination of a correction work indicates the destination of display of a correction screen used for an operation of correcting the attribute information. An administrator performs an operation of setting one of the image processing device 110 and the terminal device 120 as the work destination of the correction work. For instance, when the correction work is performed at the terminal device 120, the administrator performs an operation of setting the work destination of the correction work to the terminal device 120 using the operational unit 114 on the setting screen 140. when the correction work is performed at the image processing device 110, the administrator performs an operation of setting the work destination of the correction work to the image processing device 110 using the operational unit 114 on the setting screen 140. When the work destination of the correction work is set to the image processing device 110, the administrator may set a condition for serving the image processing device 110 as the work destination of the correction work. When the condition is not set after the work destination of the correction work is set to the image processing device 110, the image processing device 110 is the work destination of the correction work unconditionally.

The condition includes a condition for the processing time, a condition for the number of pages, and a condition for the number of extracted results. The condition for the processing time includes the upper limit of the processing time. The processing time is the time it takes since the start of reading a document until the correction screen is displayed. The processing is longer, for instance, when the resolution of a document image is high or a document image is unclear. Here, as illustrated in FIG. 4, it is assumed that the upper limit of the processing time is set to 20 seconds. In this case, when the processing time is less than or equal to 20 seconds, the work destination of the correction work is set to the image processing device 110 as in the setting made by the administrator. However, when the processing time exceeds 20 seconds, the display destination of the correction screen is the terminal device 120 which is different from the setting made by the administrator. The condition for the number of pages includes the upper limit of the number of pages of a document image. Here, as illustrated in FIG. 4, it is assumed that the upper limit of the number of pages is set to 10 pages. In this case, when the number of pages of a document image is less than or equal to 10 pages, the work destination of the correction work is the image processing device 110 as in the setting made by the administrator. However, when the number of pages exceeds 10 pages, the display destination of the correction screen is the terminal device 120 which is different from the setting made by the administrator. The condition for the number of extracted results includes the upper limit of the number of extracted results. The number of extracted results is the number of pieces of attribute information extracted from the document image, in other words, the number of results of character recognition extracted from the document image. Here, as illustrated in FIG. 4, it is assumed that the upper limit of the number of extracted results is set to 10 pieces. In this case, when the number of extracted results is less than or equal to 10 pieces, the work destination of the correction work is the image processing device 110 as in the setting made by the administrator. However, when the number of extracted results exceeds 10 pieces, the display destination of the correction screen is the terminal device 120 which is different from the setting made by the administrator.

Furthermore, on the setting screen 140, in addition to the display destination of the correction screen, a communication address of the terminal device 120 and necessary information for transfer of data to the terminal device 120 are set. The information set on the setting screen 140 in this manner is stored in the memory 112 as the setting information.

### 2.2 Attribute Extraction Processing

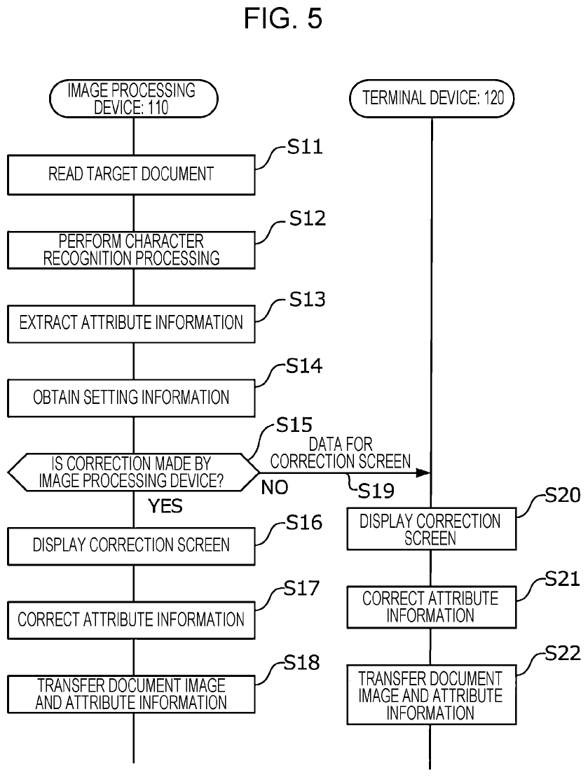

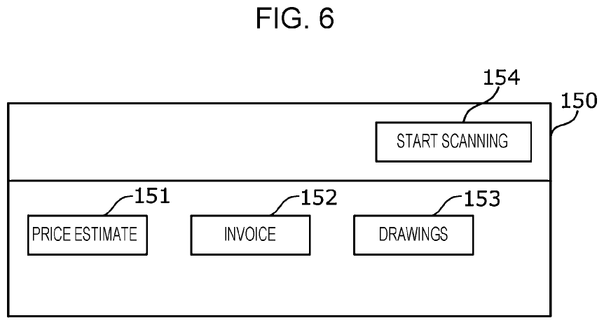

FIG. 5 is a sequence chart illustrating an example of attribute extraction processing performed in the attribute extraction system 100. First, a menu screen 150 for attribute extraction processing is displayed on the display 115 of the image processing device 110. FIG. 6 is a diagram illustrating an example of the menu screen 150. The menu screen 150 includes selection buttons 151 to 153 that receive an operation of selecting a document type, and a start button 154 that receive an operation of commanding the start of reading an image. For instance, when attribute information is extracted from a price estimate, after selecting the selection button 151 corresponding to price estimate using the operational unit 114, a user performs an operation of pressing the start button 154.

In step S11, the processor 111 of the image processing device 110 causes the image reader 116 to read a target document according to an operation of a user. Thus, a document image 160 showing the target document is obtained.

In step S12, the processor 111 performs character recognition on the document image 160 obtained in step S11 by OCR. Consequently, the characters included in the document image 160 are recognized.

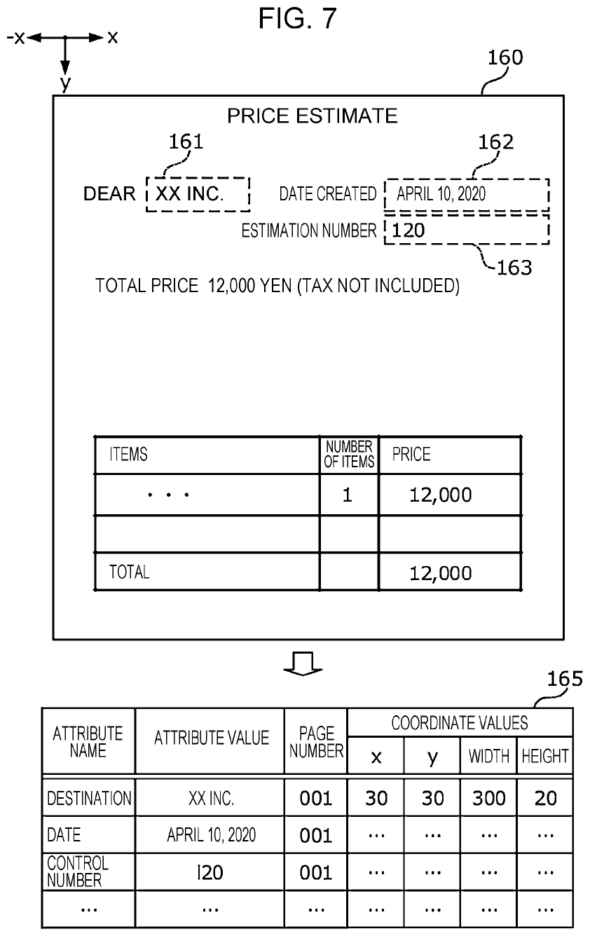

In step S13, the processor 111 extracts attribute information by Key-Value extraction technique from the document image 160 which has undergone character recognition processing. FIG. 7 is a view illustrating an example of the document image 160. The x-axis direction and the y-axis direction illustrated in FIG. 7 indicate perpendicular directions to each other. Also, -x-axis direction indicates the direction opposite to the x-axis direction. Here, it is assumed that the keys: “DEAR”, “DATE OF CREATION”, “ESTIMATE NUMBER” are set in advance. The attribute information “XX INC.”, “APRIL 10, 2020”, and “120” are respectively extracted from the peripheral ranges 161 to 163 of these keys contained in the document image 160. The peripheral ranges are each an area determined relative to the position of a key. For instance, as illustrated in FIG. 7, for the key called “DEAR”, the peripheral range 161 is determined in advance, which is within a defined distance from the position of the key in -x-axis direction. Similarly, for the keys “DATE OF CREATION”, “ESTIMATE NUMBER”, the peripheral ranges 162, 163 are determined in advance, which are within respective defined distances from the positions of these keys in -x-axis direction. When the format of attribute information is determined in advance, the information in a predetermined format out of the information included in the peripheral ranges 161 to 163 is extracted as the attribute information. It is to be noted that a method of extracting the attribute information from the document image 160 is not limited to the one using the Key-Value technique. For instance, a user may draw a line using a marker, which surrounds a portion where attribute information is written on a target document, and may extract the attribute information from the range surrounded by the line.

In step S14, the processor 111 reads and extracts setting information from the memory 112. In step S15, the processor 111 determines based on the setting information obtained in step S14 whether the attribute information obtained in step S13 is corrected at the image processing device 110. The display destination of the correction screen is switched by the determination. For instance, when the setting information indicates that the work destination of the correction screen is set to the image processing device 110, the setting information indicates that a condition for allowing the image processing device 110 to be the work destination of the correction screen is not set, or the setting information indicates that the condition is set, and when the condition is satisfied, it is determined that the attribute information is corrected at the image processing device 110 (the determination in step S15 is YES).

For instance, as illustrated in FIG. 4, when the work destination of the correction screen is set to the image processing device 110, and the condition for the processing time, the condition for the number of pages, and the condition for the number extracted results are set, it is determined whether these conditions are satisfied. First, in step S11, the processing time it takes since the start of reading a target document until the correction screen is displayed. The processing time is calculated based on, for instance, the data volume of the document image 160 and the number of pieces of attribute information extracted from the document image 160 in step S13. For instance, when the processing time is within 20 seconds as an upper limit, the condition for the processing time is determined to be satisfied. Subsequently, the number of pages of the document image 160 obtained in step S11 is calculated. For instance, when the number of pages is less than or equal to 10 pages as an upper limit, the condition for the number of pages is determined to be satisfied. In addition, the number of pieces of attribute information extracted in step S13 is calculated. For instance, when the number of pieces of attribute information is less than or equal to 10 pieces as an upper limit, the condition for the number of pieces of attribute information is determined to be satisfied. Like this, when the work destination of the correction work is set to the image processing device 110, and the condition for the processing time, the condition for the number of pages, and the condition for the number extracted results are set, and in the case where the condition for the processing time, the condition for the number of pages, and the condition for the number extracted results are all satisfied, it is determined that the attribute information is corrected at the image processing device 110. In this case, the processor 111 proceeds to the processing in step S16.

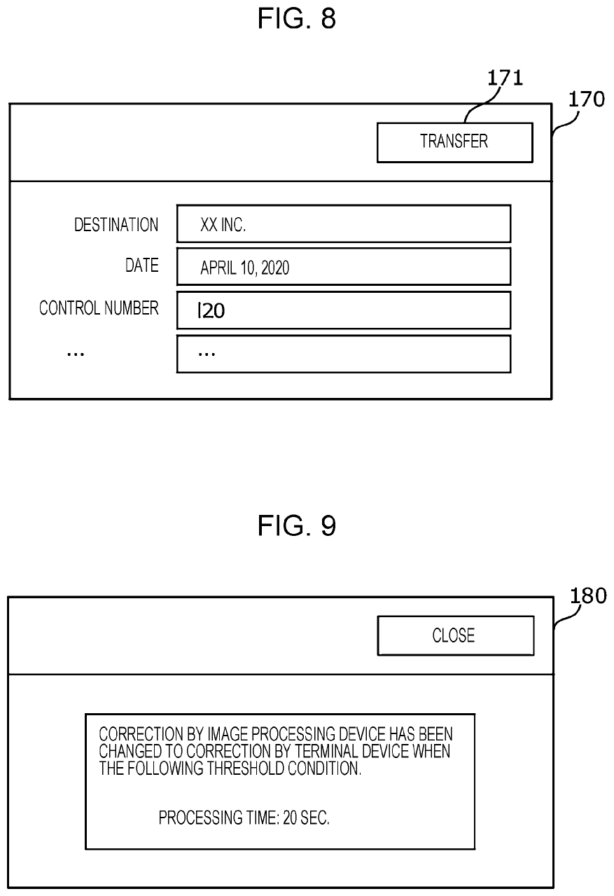

In step S16, the processor 111 displays a correction screen 170 on the display 115. FIG. 8 is a view illustrating an example of the correction screen 170. The correction screen 170 receives an operation of correcting the result of character recognition of the attribute information extracted in step S13. The correction screen 170 contains the attribute information extracted in step S13. A user looks at the correction screen to check the result of character recognition of the attribute information. When the result of character recognition of the attribute information is incorrect, a user performs an operation of correcting the result of character recognition using the operational unit 114. For instance, when the numeral “1” contained in the control number “120” is falsely recognized as the lower-case English letter “l”, a user performs an operation of correcting the lower-case English letter “l” to the numeral “1”. It is to be noted that when a keyboard is not contained in the operational unit 114, a software keyboard may be contained in the correction screen 170.

In step S17, the processor 111 corrects the result of character recognition of the attribute information according to an operation of a user. For instance, when a user performs an operation of correcting the Lower-case English letter “l” contained in the control number “120” to the numeral “1”, the result of the character recognition of the control number is corrected according to the operation.

In step S18, according to an operation of a user, the processor 111 transfers the document image 160 obtained in step S11 and the attribute information extracted in step S13 to a transfer destination specified. For instance, when a user performs an operation of pressing a transfer button 171 of the correction screen 170 illustrated in FIG. 8 using the operational unit 114, the document image 160 and the attribute information are transferred. In this process, when the attribute information has been corrected in step S17, the attribute information after being corrected is transferred. The transfer destination is specified in advance by an operation of an administrator or a user, for instance. The transfer destination may be a cloud server device connected via the communication line 130, for instance.

The attribute information is stored in the property of the file of the document image 160. The attribute information is assigned to the document image 160 according to a predetermined assignment rule, for instance. The assignment rule includes, for instance, the assignment rule for file name and the assignment rule for folder name. These assignment rules are set in the initial setting, for instance. It is assumed that the assignment rule for file name of price estimate is set to “GROUP 1_[DESTINATION]_[CONTROL NUMBER]”. The assignment rule shows that the file name of price estimate includes the character string “GROUP 1”, attribute information indicating a destination, attribute information indicating a control number in that order, and that the character string “GROUP 1” and the attribute information indicating a destination, and the attribute information indicating a destination and the attribute information indicating a control number are each delimited by an under score. When the attribute information extracted from the document image 160 and indicating a destination is “XX INC.”, and the attribute information indicating a control number is “120”, the file name of the document image 160 is “GROUP 1_XX INC._120”. Also, it is assumed that the assignment rule for folder name of price estimate is set to “PRICE ESTIMATE_[DATE]”. The assignment rule shows that the name of folder storing price estimates includes the character string “ESTIMATE” and attribute information indicating a date in that order, and that the character string “PRICE ESTIMATE” and the attribute information indicating a date are delimited by an under score. For instance, when the attribute information extracted from the document image 160 and indicating a date is “APRIL 10, 2020”, the folder name storing the document image 160 is “PRICE ESTIMATE_APRIL 10, 2020”.

In step S15 described above, for instance, when the setting information indicates that the work destination of the correction work is set to the terminal device 120, or when the setting information indicates that the work destination of the correction work is set to the image processing device 110 and the setting information indicates that a condition for allowing the image processing device 110 to be the work destination of the correction work is not set and the condition is not satisfied, it is determined that the attribute information is corrected at the terminal device 120 (the determination in step S15 is NO). For instance, when the work destination of the correction work is set to the terminal device 120 in the setting screen 140 illustrated in FIG. 4, it is determined that the attribute information is corrected at the terminal device 120. As illustrated in FIG. 4, when the work destination of the correction work is set to the image processing device 110, and a condition for the processing time, a condition for the number of pages, and a condition for the number of extracted results are set, and yet one of the condition for the processing time, the condition for the number of pages, and the condition for the number of extracted results is not satisfied, it is determined that the attribute information is corrected at the image processing device 110. For instance, when the processing time exceeds 20 seconds as an upper limit, the condition for the processing time is not satisfied. When the number of pages of the document image 160 exceeds 10 pages as an upper limit, the condition for the number of pages is not satisfied. When the number of pieces of attribute information exceeds 10 pieces as an upper limit, the condition for the number of extracted results is not satisfied. In this case, the processor 111 proceeds to the processing in step S19.

In step S19, the processor 111 creates data for correction screen, and transmits the data to the terminal device 120. The data for correction screen includes the document image 160 obtained in step S11, extraction result data 165, and the assignment rule. The extraction result data 165 and the assignment rule are stored in the file of the document image 160, for instance. The extraction result data 165 includes the attribute information extracted in step S13, the identifier of the attribute information, and positional information on the attribute information. For instance, as illustrated in FIG. 7, the extraction result data 165 includes an attribute name, an attribute value, a page number, and coordinate values. The attribute name is information that uniquely identifies the attribute information extracted in step S13. The attribute value is attribute information. The page number is information that uniquely identifies the page in which the attribute information is extracted. The coordinate values include the coordinate values which indicate the position of the representative point of the attribute information in the x-axis direction and the y-axis direction on the page. The representative point may be, for instance, one of the corners of the outer circumscribed rectangle of the attribute information. In addition, the coordinate values include the values which indicate the width and the height of the attribute information on the page. The width indicates the length in the x-axis direction illustrated in FIG. 7. The height indicates the length in the y-axis direction illustrated in FIG. 7. As described above, the assignment rule includes, for instance, the assignment rule for file name and the assignment rule for folder name, and is set in advance in the initial setting.

In step S15 described above, when the work destination of the correction work is set to the image processing device 110 and yet it is determined that the attribute information is corrected at the terminal device 120 because a predetermined condition is not satisfied, the processor 111 displays on the display 115 a notification screen 180 which notifies that the work destination of the correction work is changed. FIG. 9 is a view illustrating an example of the notification screen 180. The notification screen 180 includes a message which tells that the work destination of the correction work has been changed from the image processing device 110 to the terminal device 120. In addition, the notification screen 180 includes information which indicates one or more conditions not satisfied out of the condition for the processing time, the condition for the number of pages, and the condition for the number of extracted results. For instance, when the processing time exceeds 20 seconds as an upper limit, as illustrated in FIG. 9, the notification screen 180 displays the processing time as an upper limit.

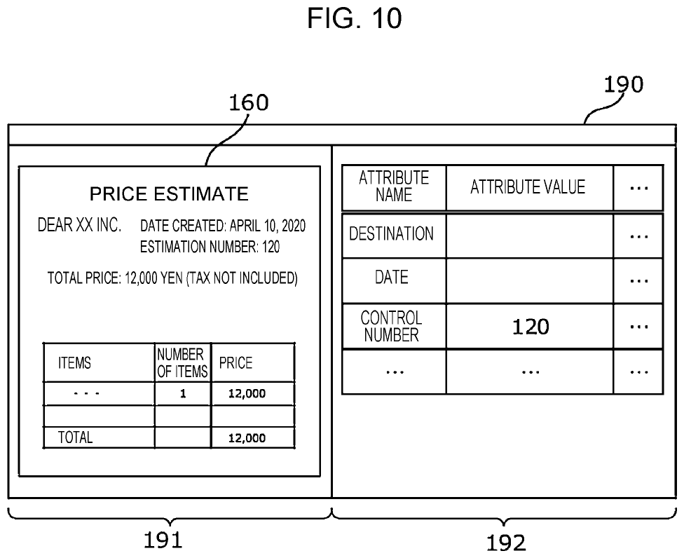

In step S20, the processor 121 displays a correction screen 190 on the display 125 based on the data for correction screen received from the image processing device 110. FIG. 10 is a view illustrating an example of the correction screen 190. Similarly to the correction screen 170 illustrated in FIG. 8, the correction screen 190 receives an operation of correcting the result of character recognition of the attribute information extracted in step S13. The correction screen 170 and the correction screen 190 have a substantially common manner of operation. However, in the correction screen 190, a region 191 and a region 192 are divided. Similarly to the correction screen 170 illustrated in FIG. 8, the region 192 includes the attribute information extracted in step S13. The attribute information is included in the data for correction screen. In contrast, the region 191 includes the document image 160 included in the data for correction screen. A user looks at the correction screen 190 to check the result of character recognition of the attribute information. At this point, when a user performs an operation of selecting one of the pieces of attribute information included in the region 192 using the operational unit 124, the piece of attribute information selected in the document image 160 displayed on the region 191 is displayed in highlight based on the page number and the coordinate values included in the data for correction screen. When the result of character recognition of the attribute information is incorrect, a user performs an operation of correcting the result of character recognition using the operational unit 114. For instance, when the numeral “1” contained in the control number “120” is falsely recognized as the Lower-case English letter “l”, a user performs an operation of correcting the Lower-case English letter “l” to the numeral “1”.

Like this, when the work destination of the correction work is set to the terminal device 120 in the initial setting, the display destination of the correction screen is determined to be the terminal device 120. However, when the work destination of the correction work is set to the image processing device 110 in the initial setting, and a condition for allowing the work destination of the correction work to be the image processing device 110 is not set, the display destination of the correction screen is determined to be the image processing device 110. Thus, the display destination of the correction screen is switched according to an operation of a user, and the correction screen is displayed on the display destination set by an operation of a user. Also, when the work destination of the correction work is set to the image processing device 110 in the initial setting, and a condition for allowing the work destination of the correction work to be the image processing device 110 is set, in the case where the condition is satisfied, the display destination of the correction screen is determined to be the image processing device 110. However, in the case where the condition is not satisfied, the display destination of the correction screen is determined to be the terminal device 120. Thus, the display destination of the correction screen is switched according to a predetermined condition.

In step S21, similarly to the processing in step S17 described above, the processor 121 corrects the result of character recognition of the attribute information according to an operation of a user. For instance, when a user performs an operation of correcting the Lower-case English letter “l” contained in the control number “120” to the numeral “1”, the result of the character recognition of the control number is corrected according to the operation.

In step S22, similarly to the processing in step S18 described above, the processor 121 transfers the document image 160 and the attribute information included in the data for correction screen to a transfer destination specified. For instance, when a user performs an operation of commanding transfer on the correction screen illustrated in FIG. 10, the document image 160 and the attribute information are transferred. At this point, when the attribute information has been corrected in step S21, the attribute information after being corrected is transferred. As described above, the attribute information is stored in the property of the file of the document image 160. The attribute information is assigned to the document image 160 according to the assignment rule included in the data for correction screen, for instance.

According to the exemplary embodiment described above, the display destination of the correction screen is switched between the image processing device 110 and the terminal device 120, thus an operation of correcting the result of character recognition is performed more easily, as compared with when the correction screen is always displayed on a specific display destination, for instance, one of the image processing device 110 and the terminal device 120.

In general, the display 115 of the image processing device 110 has a small screen size, and the operational unit 114 does not include an input device, such as a mouse and a keyboard, which is suitable for operation of inputting characters and numerals. Thus, when the number of pages and the number of extracted results of a document image are large, it may be difficult to perform a correction work at the image processing device 110. In such a case, when the display destination of the correction screen is set to the terminal device 120, an operation of correcting the result of character recognition can be performed at the terminal device 120, and thus the operation of correcting the result of character recognition is easily performed.

In general, the image processing device 110 is shared by multiple users. Thus, when a correction work requiring a long processing time is performed at the image processing device 110, one user uses the image processing device 110 for a long time, and other users cannot use the image processing device 110 during that time. In such a case, when the display destination of the correction screen is changed to the terminal device 120, the user can perform an operation of correcting the result of character recognition at the terminal device 120 without giving consideration to other users of the image processing device 110, thus an operation of correcting the result of character recognition is easily performed.

Meanwhile, in order to perform a correction work at the terminal device 120, a paid program necessary for correcting the result of character recognition of attribute information needs to be installed in the terminal device 120. When such a program is not installed in the terminal device 120 of a user, if the display destination of the correction screen is switched to the image processing device 110, an operation of correcting the result of character recognition can be performed at the image processing device 110 even if a program necessary for correcting the result of character recognition of attribute information is not installed in the terminal device 120.

When it is determined that the attribute information is corrected at the terminal device 120, the data for correction screen including the result of character recognition is transmitted to the terminal device 120, thus even when the image processing device 110 which is the subject that performs character recognition and the terminal device 120 as the display destination of the correction screen are different, the terminal device 120 as the display destination can display the correction screen 190 that receives an operation of correcting the result of character recognition.

In addition, the display destination of the correction screen is determined to be the image processing device 110 or the terminal device 120, thus a user can perform an operation of correcting the result of character recognition at a desired display destination. Furthermore, since a display destination of the correction screen is set in the initial setting, it is possible to set a display destination of the correction screen which receives an operation of correcting the result of character recognition when the initial setting is made.

In addition, the display destination of the correction screen is determined to be the image processing device 110 or the terminal device 120 according to a predetermined condition, it is possible to switch to a display destination of the correction screen which receives an operation of correcting the result of character recognition without an operation of a user. Since the predetermined condition includes a condition for the number of pages, an operation of correcting the result of character recognition can be performed at a display destination according to the number of pages of a document. Since the predetermined condition includes a condition for the number of extracted results, an operation of correcting the result of character recognition can be performed at a display destination according to the number of results of character recognition extracted from the document image. Since the predetermined condition includes a condition for the processing time, an operation of correcting the result of character recognition can be performed at a display destination according to the processing time.

### 3. MODIFIED EXAMPLE

The exemplary embodiment described above is an example of the present disclosure. The present disclosure is not limited to the above-described exemplary embodiment. The above-described exemplary embodiment may be modified and implemented as in the following example. Two or more of the following modified examples may be combined and used.

### 3.1 Modified Example 1

In the exemplary embodiment described above, the display destination of the correction screen may be switched by a factor which is different from the one in the example described above. For instance, the display destination of the correction screen may be switched to the terminal device 120 according to the situation of the image processing device 110. The situation of the image processing device 110 is a situation considered to be unfavorable when a correction work is performed at the image processing device 110, such as a situation where the number of processing commands to the image processing device 110, which have not been executed is greater than or equal to a threshold value, and a situation where the number of users on a waiting list for the image processing device 110 is greater than or equal to a threshold value. The number of processing commands to the image processing device 110, which have not been executed is obtained, for instance, by counting the number of processing commands not yet executed out of the processing commands to the image processing device 110. The number of users on a waiting list is obtained, for instance, by providing the image processing device 110 with an image capture device, such as a camera, which captures the front of the image processing device 110, and analyzing an image captured by the image capture device. For instance, when five users waiting in front of the image processing device 110 are recognized from the captured image, the number of users on a waiting list for the image processing device 110 is five. In a situation where the number of processing commands to the image processing device 110, which have not been executed is greater than or equal to a threshold value, or a situation where the number of users on a waiting list for the image processing device 110 is greater than or equal to a threshold value, the display destination of the correction screen may be determined to be the terminal device 120 regardless of the setting information. For instance, when the work destination of the correction work is set to the image processing device 110, and the condition for the processing time, the condition for the number of pages, and the condition for the number of extracted results are set, and these conditions are satisfied, the display destination of the correction screen may be determined to be the terminal device 120.

In another example, the display destination of the correction screen may be switched according to the attribute of the result of character recognition. For instance, when the result of character recognition of the attribute information has an attribute which is easily corrected, the display destination of the correction screen may be determined to be the image processing device 110 regardless of the setting information. The attribute which is easily corrected includes, for instance, a format having only numerals. For instance, even when the work destination of the correction work is set to the terminal device 120, or when the setting information indicates that the work destination of the correction work is set to the terminal device 120 and the image processing device 110 does not satisfy a condition for the work destination of the correction work, the display destination of the correction screen may be changed from the terminal device 120 to the image processing device 110. This is because when the attribute information includes only numerals, an operation of correcting the attribute information is easily performed, thus it is sufficient that the attribute information be corrected at the image processing device 110 without using the terminal device 120. However, when the result of character recognition of the attribute information has an attribute which is not easily corrected, the display destination of the correction screen may be determined to be the terminal device 120 regardless of the setting information. The attribute which is not easily corrected includes, for instance, a format having characters. For instance, even when the work destination of the correction work is set to the image processing device 110, and the condition for the processing time, the condition for the number of pages, and the condition for the number of extracted results are set, and these conditions are satisfied, the display destination of the correction screen may be changed from the image processing device 110 to the terminal device 120. This is because when the attribute information includes characters, an operation of inputting a character needs to be performed to correct the attribute information, and an operation of correcting the attribute information is performed more easily with the terminal device 120. When the number of pieces of attribute information with a reliability level of the result of character recognition lower than a reference value is greater than or equal to a threshold value, the display destination of the correction screen may be determined to be the terminal device 120 regardless of the setting information. The reliability level is determined by a known technique, for instance. When the image quality of the document image 160 is low, such as a thin or dirty target document, the reliability level is reduced. When the attribute information with a reliability level of the result of character recognition lower than a reference value has an attribute which is easily corrected, the display destination of the correction screen may be determined to be the image processing device 110. In addition, when the character size of the result of character recognition is smaller than a reference value, the display destination of the correction screen may be determined to be the terminal device 120 regardless of the setting information. This is because when the character size of the result of character recognition is small, the rate of false recognition tends to be high, and thus an operation of correction is performed more easily at the terminal device 120.

In another example, the display destination of the correction screen may be switched according to the configuration of the image processing device 110 or the terminal device 120. For instance, when the screen size of the display 115 of the image processing device 110 is smaller than a threshold value, the display destination of the correction screen may be determined to be the terminal device 120 regardless of the setting information. In addition, when the operational unit 114 of the image processing device 110 does not include a keyboard, the display destination of the correction screen may be determined to be the terminal device 120 regardless of the setting information. Furthermore, when a value indicating the performance of the processor 111 of the image processing device 110 is lower than a threshold value, the display destination of the correction screen may be determined to be the terminal device 120 regardless of the setting information. In contrast, when a program necessary for correcting the result of character recognition of attribute information is not installed in the terminal device 120, the display destination of the correction screen may be determined to be the image processing device 110 regardless of the setting information. In this case, the image processing device 110 makes an inquiry to the terminal device 120 about the installment of the program. Whether the program necessary for correcting the result of character recognition of the attribute information is installed in the terminal device 120 may be determined based on a reply from the terminal device 120 to the inquiry.

In another example, the display destination of the correction screen may be switched according to the attribute of a user. When a user is a non-regular employee or a part-time employee, the display destination of the correction screen may be determined to be the image processing device 110 regardless of the setting information. When a user is a non-regular employee or a part-time employee is determined, for instance, by performing user authentication at the start of use of the image processing device 110. This is because a user who is a non-regular employee or a part-time employee may not have an available terminal device 120 or even when a user has an available terminal device 120, a program necessary for correcting the result of character recognition of attribute information may not be installed in the terminal device 120.

In these modified examples, after the display destination of the correction screen is once determined by the method in the exemplary embodiment described above, the display destination of the correction screen 190 may be changed due to the factors described above. In instead of determining the display destination of the correction screen to be the image processing device 110 due to the factors described above, an upper limit included in the predetermined condition may be changed so that the image processing device 110 is likely to be determined as the display destination of the correction screen. For instance, the upper limit of the processing time may be changed to a time longer than 20 seconds. The upper limit of the number of pages may be changed to a number longer than 10 pages. The number of extracted results may be changed to a number greater than 10 pieces. Similarly, in instead of determining the display destination of the correction screen to be the terminal device 120 due to the factors described above, an upper limit included in the predetermined condition may be changed so that the terminal device 120 is likely to be determined as the display destination of the correction screen. For instance, the upper limit of the processing time may be changed to a time shorter than 20 seconds. The upper limit of the number of pages may be changed to a number shorter than 10 pages. The number of extracted results may be changed to a number smaller than 10 pieces.

### 3.2 Modified Example 2

In the exemplary embodiment described above, the display destination of the correction screen may be changed during a period since the start of receiving an operation related to reading of a target document until the correction screen is displayed. For instance, the menu screen 150 illustrated in FIG. 6 may include a change button which receives an operation of changing the display destination from the image processing device 110 to the terminal device 120. The change button is an example of the operation image according to the present disclosure. The screen displayed on the display 115 may include the change button during a period in which a target document is being read. When a user performs an operation of pressing the change button using the operational unit 114, the display destination of the correction screen is changed from the image processing device 110 to the terminal device 120. Thus, the correction screen 190 is displayed on the terminal device 120. According to the modified example, when a document is being read, it is possible to change the display destination of the correction screen which receives an operation of correcting the result of character recognition.

In addition, the display destination of the correction screen may be changed during a period since the start of receiving operation related to reading of a target document until the correction screen is displayed as long as the image processing device 110 is in a specific situation. The specific situation is, for instance, the above-described situation which is considered to be unfavorable when a correction work is performed at the image processing device 110. When the exemplary embodiment is implemented in combination with an above-described modified example in which the display destination of the correction screen is switched according to the situation of the image processing device 110, a message may be displayed along with the change button, the message indicating that the display destination of the correction screen is likely to be changed to the terminal device 120.

### 3.3 Modified Example 3

In the exemplary embodiment described above, after the correction screen 170 is displayed at the image processing device 110, the display destination of the correction screen may be changed. For instance, the correction screen 170 illustrated in FIG. 8 may include a change button which receives an operation of changing the display destination from the image processing device 110 to the terminal device 120. The change button is an example of the operation image according to the present disclosure. When a user performs an operation of pressing the change button using the operational unit 114, the display destination of the correction screen is changed from the image processing device 110 to the terminal device 120. Thus, data for correction screen is transmitted from the image processing device 110 to the terminal device 120, and the correction screen 190 is displayed on the terminal device 120. According to the modified example, after the correction screen is displayed, the display destination of the correction screen can be changed to another display destination.

### 3.4 Modified Example 4

In the exemplary embodiment described above, the predetermined condition is not limited to the condition for the processing time, the condition for the number of pages, and the condition for the number of extracted results. For instance, the predetermined condition may include a condition for the number of extracted pages. The condition for the number of extracted pages includes an upper limit of the number of pages from which attribute information is extracted out of the pages of a document image. For instance, when a document image has 10 pages, attribute information is extracted from eight pages out of the 10 pages, and attribute information is not extracted from the remaining two pages, the number of pages from which attribute information is extracted is eight. When the number of pages extracted is less than or equal to the upper limit, the display destination of the correction screen is changed to the image processing device 110 as in the setting made by an administrator. When the number of pages extracted exceeds the upper limit, the display destination of the correction screen is set to the terminal device 120 which is different from the setting made by an administrator. According to the modified example, an operation of correcting the result of character recognition can be performed at a display destination according to the number of pages from which the result of character recognition is extracted.

### 3.5 Modified Example 5

In the exemplary embodiment described above, the correction screens 170 and 190 are not limited to the respective examples illustrated in FIG. 8 and FIG. 10. For instance, similarly to the correction screen 190 illustrated in FIG. 10, the correction screen 170 may include the document image 160. Also, the result of character recognition of all the attribute information may not be necessarily included in the correction screens 170 and 190. For instance, only the attribute information with a reliability level of the result of character recognition lower than a reference value may be included. In this case, for only the attribute information with a reliability level of the result of character recognition lower than a reference value, a user checks the result of character recognition, and corrects the result as needed.

### 3.6 Modified Example 6

In the exemplary embodiment described above, an external device may have part of the functions of the image processing device 110. For instance, a sever device, such as a cloud server, connected to the image processing device 110 via the communication line 130 may perform the processing in step S12 to S15 and S19 described above. In this case, when the display destination of the correction screen is determined to be the image processing device 110, the data for correction screen is transmitted from the server device to the image processing device 110.

### 3.7 Modified Example 7

In the embodiments above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### 3.8 Modified Example 8

The present disclosure may be provided as a program which is executed in the image processing device 110 or the terminal device 120. The image processing device 110 and the terminal device 120 are each an example according to the present disclosure. The program may be downloaded via a communication line such as the Internet, or may be provided, recorded on a computer-readable recording medium, such as a magnetic recording medium (such as a magnetic tape, a magnetic disk), an optical recording medium (such as an optical disc), a magneto optical recording medium, a semiconductor memory.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising a processor configured to
obtain a document image which shows a document; and
switch a display destination of a correction screen which receives an operation of correcting a result of character recognition performed on the document image.

2. The information processing device according to claim 1, wherein the display destination includes an image reading device that reads the document and a terminal device of a user.

3. The information processing device according to claim 1, wherein the processor is configured to transmit the result of the character recognition to the display destination.

4. The information processing device according to claim 1, wherein the processor is configured to switch the display destination according to an operation of a user.

5. The information processing device according to claim 4, wherein the processor is configured to
display, on a display, a setting screen which receives an operation of setting the display destination in an initial setting, and
display the correction screen on the display destination set by the operation.

6. The information processing device according to claim 5, wherein the document image is obtained by reading the document with an image reading device, and
the processor is configured to
display an operation image on a display of the image reading device in a period since start of receiving an operation related to reading of the document until the correction screen is displayed, the operation image being displayed for receiving an operation of changing the display destination which has been set, and
display the correction screen at another display destination changed by the operation of changing the display destination.

7. The information processing device according to claim 5, wherein the correction screen includes an operation image for receiving an operation of changing the display destination which has been set, and
the processor is configured to display the correction screen at another display destination changed by the operation of changing the display destination.

8. The information processing device according to claim 1, wherein the processor is configured to switch the display destination according to a predetermined condition.

9. The information processing device according to claim 8, wherein the condition includes a number of pages of the document image.

10. The information processing device according to claim 8, wherein the condition includes a number of pages from which the result of the character recognition is extracted, the pages being included in the document image.

11. The information processing device according to claim 8, wherein the condition includes a number of results of the character recognition, the results being extracted from the document image.

12. The information processing device according to claim 8, wherein the document image is obtained by reading the document with an image reading device, and
the condition includes a time from start of reading the document to start of displaying of the correction screen.

13. The information processing device according to claim 2, wherein the processor is configured to switch the display destination to the terminal device according to a situation of the image reading device.

14. The information processing device according to claim 1, wherein the processor is configured to switch the display destination according to an attribute of the result of the character recognition.

15. The information processing device according to claim 14, wherein the processor is configured to
determine the display destination according to a predetermined condition, and
change the determined display destination according to the attribute of the results of the character recognition.

16. A non-transitory computer readable medium storing a program causing a computer to execute a process comprising:
obtaining a document image which shows a document; and
switching a display destination of a correction screen which receives an operation of correcting a result of character recognition performed on the document image.

17. An information processing device comprising:
means for obtaining a document image which shows a document; and
means for switching a display destination of a correction screen which receives an operation of correcting a result of character recognition performed on the document image.
